(19) United States
(12) Patent Application Publication
(10) Pub. No.: US 2024/0331902 A1
(43) Pub. Date: Oct. 3, 2024

(54) MAGNETIC BASE BODY, COIL COMPONENT INCLUDING THE MAGNETIC BASE BODY, CIRCUIT BOARD INCLUDING THE COIL COMPONENT, AND ELECTRONIC DEVICE INCLUDING THE CIRCUIT BOARD

(71) Applicant: TAIYO YUDEN CO., LTD., Tokyo (JP)

(72) Inventors: Tatsuya TOMITA, Tokyo (JP); Tomoya HAGIWARA, Tokyo (JP)

(21) Appl. No.: 18/616,277

(22) Filed: Mar. 26, 2024

(30) Foreign Application Priority Data
Mar. 31, 2023 (JP) 2023-058011

(51) Int. Cl. H01F 1/24; H01F 1/33; H01F 27/255; H01F 41/02

(52) U.S. Cl. CPC H01F 1/24; H01F 1/33; H01F 27/255; H01F 41/0246

(57) ABSTRACT

Provided is a magnetic base body having excellent insulating properties and magnetic properties. A magnetic base body according to one embodiment includes: a plurality of soft magnetic metal particles; and a plurality of insulating films each covering a surface of corresponding one of the plurality of soft magnetic metal particles. In the magnetic base body, the plurality of soft magnetic metal particles are filled at a filling factor of 85% or higher. The KAM value of the soft magnetic metal particles is 0.6 or less. The soft magnetic metal particles contain 95 wt % or more Fe, Si, and Al. The insulating films contain an oxide of Si and an oxide of Al.

### CROSS-REFERENCE TO RELATED APPLICATIONS

This application is based on and claims the benefit of priority from Japanese Patent Application Serial No. 2023-058011 (filed on Mar. 31, 2023), the contents of which are hereby incorporated by reference in their entirety.

### TECHNICAL FIELD

The present disclosure relates mainly to a magnetic base body, a coil component including the magnetic base body, a circuit board including the coil component, and an electronic device including the circuit board.

### BACKGROUND

Soft magnetic base bodies containing a large number of soft magnetic metal particles made of a soft magnetic material are used as magnetic base bodies of coil components. In the soft magnetic base body, the surfaces of the soft magnetic metal particles are covered with insulating films, and adjacent soft magnetic metal particles are bonded to each other via the insulating films. Since the soft magnetic base body is less prone to magnetic saturation than a magnetic base body made of ferrite, the soft magnetic base body is suitable particularly for coil components used in large-current circuits.

International Publication No. WO 2018/180659 discloses a process including: pressure-forming Fe—Si based soft magnetic metal particles composed mainly of Fe and Si into a compact; performing primary heating of the compact at a temperature from 500 to 800° C. under a first oxygen partial pressure described in paragraph [0034] of the Publication to mitigate the distortion in the pressure-formed compact; and then performing secondary heating of the compact under a second oxygen partial pressure higher than the first oxygen partial pressure to form oxide films made of an oxide of Si around the soft magnetic metal particles.

In order to increase the magnetic permeability of the magnetic base body, it is desirable to increase the proportion of the soft magnetic metal particles in the magnetic bas body (filling factor). The filling factor of the soft magnetic metal particles in the magnetic base body can be increased by fabricating a compact of the soft magnetic metal particles under a high compacting pressure in the production process of the magnetic base body.

However, when the compact is pressure-formed under a high pressure, the gaps between the soft magnetic metal particles are made smaller, making it difficult to supply sufficient oxygen to form oxide films on the surfaces of the soft magnetic metal particles during heating. Therefore, as the filling factor of the soft magnetic metal particles in the magnetic base body is higher, oxide films are not sufficiently formed on the surfaces of the soft magnetic metal particles, and as a result, electrical insulation between the soft magnetic metal particles cannot be ensured.

In addition, when the compact is pressure-formed under a high pressure, there is a problem of increased distortion in the magnetic base body after heating. Increased distortion of the magnetic base body increases the coercive force which leads to a large magnetic loss.

### SUMMARY

It is an object of the present disclosure to solve or alleviate at least part of the drawbacks mentioned above. More specifically, one object of the invention disclosed herein is to provide a magnetic base body having excellent insulation properties and magnetic properties.

Other objects of the disclosure will be made apparent through the entire description in the specification. The invention disclosed herein may also address drawbacks other than that grasped from the above description. When an advantageous effect of an embodiment is described herein, the advantageous effect suggests an object of the invention corresponding to the embodiment.

A magnetic base body according to one embodiment comprises: a plurality of soft magnetic metal particles; and a plurality of insulating films each covering a surface of corresponding one of the plurality of soft magnetic metal particles. In the magnetic base body, the plurality of soft magnetic metal particles are filled at a filling factor of 85% or higher. The KAM value of the soft magnetic metal particles is 0.6 or less. The soft magnetic metal particles contain 95 wt % or more Fe, Si, and Al. The insulating films contain an oxide of Si and an oxide of Al.

### Advantageous Effects

According to the embodiments of the invention disclosed herein, it is possible to obtain a magnetic base body having excellent insulating properties and magnetic properties.

### BRIEF DESCRIPTION OF THE DRAWINGS

FIG. 1 is a schematic perspective view showing a coil component including a magnetic base body according to one embodiment of the present invention.

FIG. 2 is an exploded perspective view of the coil component shown in FIG. 1.

FIG. 3 is a sectional view schematically showing a section of the coil component of FIG. 1 along the line I-I.

FIG. 4 is an enlarged sectional view schematically showing, on an enlarged scale, a part of a section of the magnetic base body according to one embodiment.

FIG. 5 is an enlarged sectional view schematically showing, on an enlarged scale, a part of a section of the magnetic base body according to another embodiment.

FIG. 6 is an enlarged sectional view schematically showing, on an enlarged scale, a part of a section of the magnetic base body according to another embodiment.

FIG. 7 is a flow chart showing a process of manufacturing a coil component according to one embodiment of the present invention.

FIG. 8 is a flow chart showing a process of manufacturing a coil component according to another embodiment of the present invention.

### DESCRIPTION OF THE PREFERRED EMBODIMENTS

Various embodiments of the present invention will be described hereinafter with reference to the appended drawings. Throughout the drawings, the same components are denoted by the same reference numerals. For convenience of explanation, the drawings are not necessarily drawn to scale. The following embodiments of the present invention do not limit the scope of the claims. The elements included in the following embodiments are not necessarily essential to solve the problem addressed by the invention.

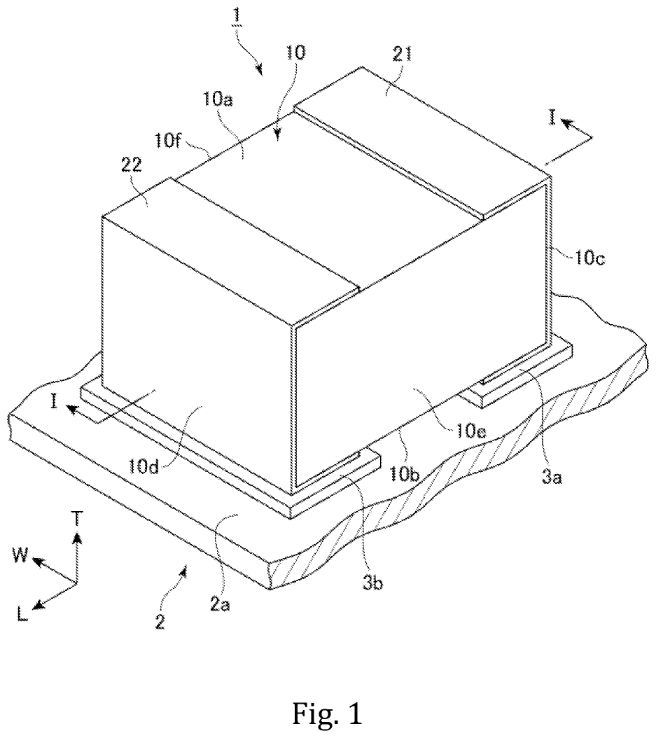

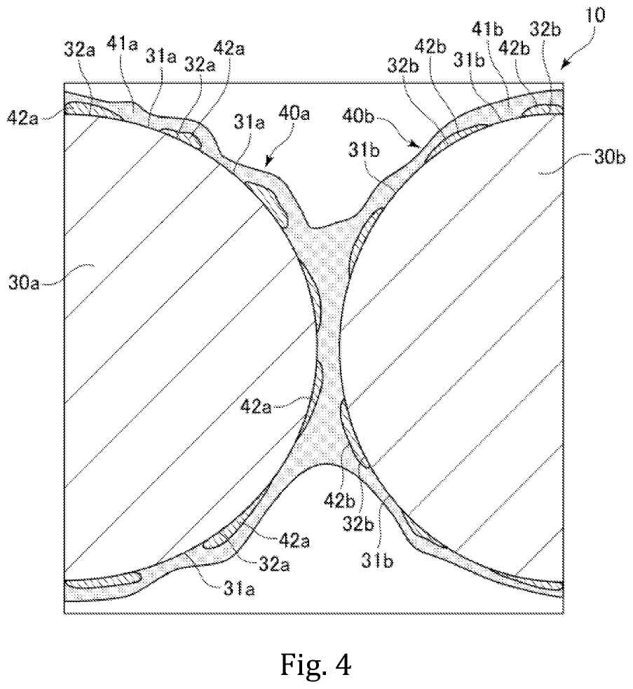

One embodiment of the present disclosure relates to a magnetic base body of a coil component. The magnetic base body contains a plurality of soft magnetic metal particles. The following first describes a coil component 1 including a magnetic base body relating to one embodiment with reference to FIGS. 1 to 3, and then the microstructure of the magnetic base body with reference to FIG. 4.

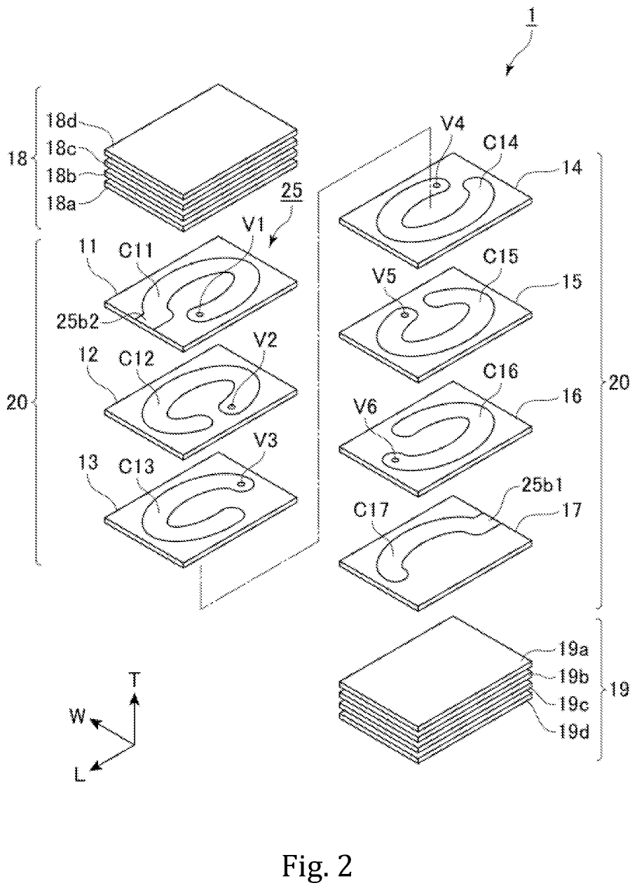

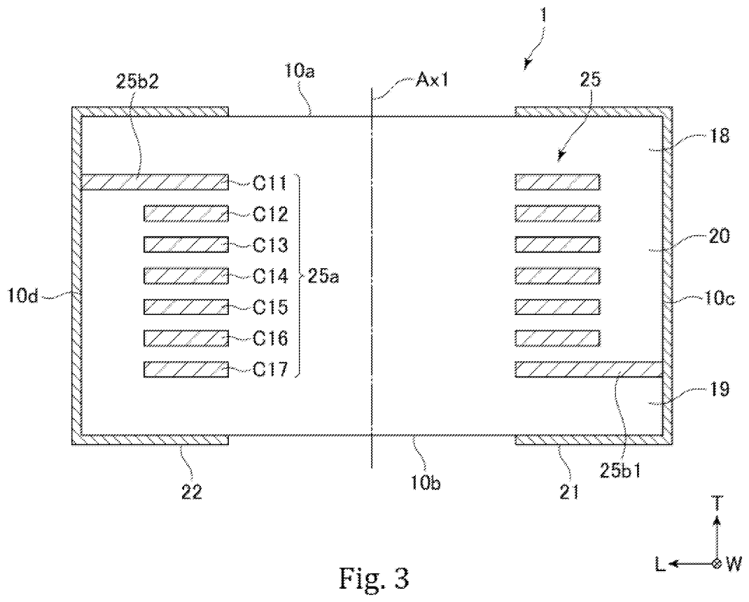

FIG. 1 is a schematic perspective view of the coil component 1, and FIG. 2 is an exploded perspective view of the coil component 1. FIG. 3 is a schematic sectional view of the coil component 1 along the line I-I of FIG. 1. In FIG. 2, external electrodes are not shown for convenience of description.

By way of one example of the coil component 1, FIGS. 1 to 3 show a laminated inductor. The laminated inductor shown is an example of the coil component 1 to which the invention can be applied. The invention can also be applied to various coil components other than the laminated inductor. For example, the coil component 1 may be applied to wire-wound coil components or planar coils.

As shown, the coil component 1 includes a magnetic base body 10, a coil conductor 25 provided in the magnetic base body 10, an external electrode 21 disposed on a surface of the magnetic base body 10, and an external electrode 22 disposed on the surface of the magnetic base body 10 at a position spaced apart from the external electrode 21. The magnetic base body 10 is a magnetic base body made of a magnetic material. The magnetic base body 10 is an example of the “magnetic base body” recited in the claims.

The magnetic base body 10 contains a large number of soft magnetic metal particles. An average particle size of the soft magnetic metal particles contained in the magnetic base body 10 is, for example, 1 μm to 10 μm. The average particle size of the soft magnetic metal particles may be 5 μm or smaller. The average particle diameter of the soft magnetic metal particles contained in the magnetic base body 10 is determined as follows. The magnetic base body 10 is cut along the thickness direction (T-axis direction) to expose a section, and the section is scanned by a scanning electron microscope (SEM) to take an SEM image at an approximately 10000 to 50000-fold magnification. The SEM image is analyzed to determine the equivalent circle diameter (Heywood diameter) of each soft magnetic metal particle, and the average of the equivalent circle diameters of the soft magnetic metal particles is taken as the average particle diameter of the soft magnetic metal particles. The average particle diameter of the soft magnetic metal particles contained in the magnetic base body 10 may be 1 μm to 10 μm or may be 2 μm to 8 μm. Since the average particle diameter of the soft magnetic metal particles does not differ significantly from that of the raw powder, the particle size distribution of the raw powder may be measured by the laser diffraction scattering method according to JIS Z 8825, and the D50 value of the volume-based particle size distribution measured by the laser diffraction scattering method may be taken as the average particle diameter of the soft magnetic metal particles in the magnetic base body 10.

The external electrode 21 is electrically connected to one end of the coil conductor 25, and the external electrode 22 is electrically connected to the other end of the coil conductor 25.

The coil component 1 may be mounted on a mounting substrate 2a. In the embodiment shown, the mounting substrate 2a has lands 3a and 3b provided thereon. The coil component 1 is mounted on the mounting substrate 2a by bonding the external electrode 21 to the land 3a and bonding the external electrode 22 to the land 3b. A circuit board 2 according to one embodiment of the present invention includes the coil component 1 and the mounting substrate 2a having the coil component 1 mounted thereon. The circuit board 2 can be installed in various electronic devices. The electronic devices in which the circuit board 2 can be installed include smartphones, tablets, game consoles, electrical components of automobiles, servers, and various other electronic devices.

The coil component 1 may be an inductor, a transformer, a filter, a reactor, an inductor array and any one of various other coil components. The coil component 1 may alternatively be a coupled inductor, a choke coil, and any one of various other magnetically coupled coil components. Applications of the coil component 1 are not limited to those explicitly described herein.

In the case where the coil component 1 is an inductor array or a magnetically coupled coil component, the coil conductor 25 is constituted by two or more conductor sections. The two or more conductor sections constituting the coil conductor 25 are electrically insulated from each other in the magnetic base body 10.

In one embodiment of the present invention, the magnetic base body 10 is configured such that the dimension in the L-axis direction (length dimension) is greater than the dimension in the W-axis direction (width dimension) and the dimension in the T-axis direction (height dimension). For example, the length is from 1.0 mm to 6.0 mm, the width is from 0.5 mm to 4.5 mm, and the height is from 0.5 mm to 4.5 mm. The dimensions of the magnetic base body 10 are not limited to those specified herein. The term “rectangular parallelepiped” or “rectangular parallelepiped shape” used herein is not intended to mean solely “rectangular parallelepiped” in a mathematically strict sense. The dimensions and the shape of the magnetic base body 10 are not limited to those specified herein.

The magnetic base body 10 has a first principal surface 10a, a second principal surface 10b, a first end surface 10c, a second end surface 10d, a first side surface 10e, and a second side surface 10f. The outer surface of the magnetic base body 10 is defined by these six surfaces. The first principal surface 10a and the second principal surface 10b are at the opposite ends in the height direction of the magnetic base body 10, the first end surface 10c and the second end surface 10d are at the opposite ends in the length direction of the magnetic base body 10, and the first side surface 10e and the second side surface 10f are at the opposite ends in the width direction of the magnetic base body 10. As shown in FIG. 1, the first principal surface 10a, which is at the top of the magnetic base body 10, may be herein referred to as a “top surface.” Likewise, the second principal surface 10b may be herein referred to as a “lower surface” or “bottom surface.” Since the coil component 1 is disposed such that the second principal surface 10b faces the mounting substrate 2a, the second principal surface 10b may be herein referred to as “the mounting surface.” The top surface 10a and the bottom surface 10b are separated from each other by a distance equal to the height of the magnetic base body 10, the first end surface 10c and the second end surface 10d are separated from each other by a distance equal to the length of the magnetic base body 10, and the first side surface 10e and the second side surface 10f are separated from each other by a distance equal to the width of the magnetic base body 10.

As shown in FIG. 2, the magnetic base body 10 includes a body layer 20, a bottom cover layer 19 provided on the bottom-side surface of the body layer 20, and a top cover layer 18 provided on the top-side surface of the body layer 20. The top cover layer 18, bottom cover layer 19, and body layer 20 are the components of the magnetic base body 10.

The body layer 20 includes magnetic films 11 to 17. In the body layer 20, the magnetic films 17, 16, 15, 14, 13, 12 and 11 are stacked in the stated order from the negative side toward the positive side in the T-axis direction.

The magnetic films 11 to 17 respectively have conductor patterns C11 to C17 formed on the top-side surface thereof. The conductor patterns C11 to C17 each extend around a coil axis Ax1 (see FIG. 3) within a plane orthogonal to the coil axis Ax1 (the LW plane). The conductor patterns C11 to C17 are formed by, for example, printing a conductive paste made of a highly conductive metal or alloy via screen printing. The conductive paste may be made of Ag, Pd, Cu, Al, or alloys thereof. The conductive paste is produced by mixing and kneading conductive powder made of conductive materials having excellent conductivity, such as Ag, Pd, Cu, Al or alloys of these, with a binder resin and a solvent. The binder resin may be PVB resins, phenolic resins, other resins known as binder resins, or mixtures thereof. When Cu powder is used as the conductive powder, a thermally decomposable resin such as acrylic resin may be used as the binder resin to prevent excessive oxidation of the Cu powder during degreasing. The thermally decomposable resin decomposes without combustion reaction with oxygen. The thermally decomposable resin thermally decomposes in a non-oxygen atmosphere (e.g., nitrogen atmosphere) when the temperature is raised above the thermal decomposition temperature, leaving no residue. Therefore, by using a thermally decomposable resin as the binder resin, the degreasing process can be performed in a non-oxygen atmosphere. Examples of the acrylic resin for the conductive paste include (meth)acrylic acid copolymers, (meth)acrylic acid-(meth)acrylic ester copolymers, styrene-(meth)acrylic acid copolymers, or styrene-(meth)acrylic acid-(meth)acrylic ester copolymers. The solvent may be toluene, ethanol, terpineol, or mixtures of these. The conductive paste may contain modifiers for adjusting thixotropy. The conductor patterns C11 to C17 may be formed using other methods and materials. For example, the conductor patterns C11 to C17 may be formed by sputtering, ink-jetting, or other known methods.

The magnetic films 11 to 16 have vias V1 to V6, respectively, at a predetermined position therein. The vias V1 to V6 are formed by forming through holes at the predetermined positions in the magnetic films 11 to 16 so as to extend through the magnetic films 11 to 16 in the T-axis direction and filling the through holes with a conductive material. Each of the conductor patterns C11 to C17 is electrically connected to the respective adjacent conductor patterns through the vias V1 to V6.

The end of the conductor pattern C11 opposite to the end thereof connected to the via V1 is connected to the external electrode 22. The end of the conductor pattern C17 opposite to the end thereof connected to the via V6 is connected to the external electrode 21.

The top cover layer 18 includes magnetic films 18a to 18d made of a magnetic material, and the bottom cover layer 19 includes magnetic films 19a to 19d made of a magnetic material. In this specification of the present invention, the magnetic films 18a to 18d and the magnetic films 19a to 19d may be referred to collectively as “the cover layer magnetic films.” The components of the magnetic base body 10 do not necessarily have a lamination structure with a plurality of magnetic films stacked together. For example, the top cover layer 18 may be a compact formed of a magnetic material, rather than a laminate including a plurality of magnetic films 18a to 18d stacked together.

As shown in FIG. 3, the coil conductor 25 includes a winding portion 25a wound around the coil axis Ax1 extending along the thickness direction (T-axis direction), a lead-out portion 25b1 that extends from one end of the winding portion 25a to the first end surface 10c of the magnetic base body 10, and a lead-out portion 25b2 that extends from the other end of the winding portion 25a to the second end surface 10d of the magnetic base body 10. The conductor patterns C11 to C17 and the vias V1 to V6 form the winding portion 25a having a spiral shape. In other words, the winding portion 25a is constituted by the conductor patterns C11 to C17 and the vias V1 to V6.

The following now describes the microstructure of the magnetic base body 10 with reference to FIG. 4. FIG. 4 is an enlarged sectional view schematically showing, on an enlarged scale, a part of the section shown in FIG. 3. FIG. 4 schematically shows portions of two of the many soft magnetic metal particles in the magnetic base body 10.

As shown in FIG. 4, the soft magnetic metal particles contained in the magnetic base body 10 include a first soft magnetic metal particle 30a and a second soft magnetic metal particle 30b. The first soft magnetic metal particle 30a and the second soft magnetic metal particle 30b are positioned adjacent to each other. In FIG. 4, the sections of the first soft magnetic metal particle 30a and the second soft magnetic metal particle 30b are drawn to be circular for convenience. The soft magnetic metal particles contained in the magnetic base body 10 can have various sectional shapes other than the circular shape. The soft magnetic metal particles contained in the magnetic base body 10 are mainly composed of iron (Fe). The first soft magnetic metal particle 30a and the second soft magnetic metal particle 30b are examples of the soft magnetic metal particles contained in the magnetic base body 10. The description regarding the first soft magnetic metal particle 30a and the second soft magnetic metal particle 30b also applies to soft magnetic metal particles other than the first soft magnetic metal particle 30a or the second soft magnetic metal particle 30b contained in the magnetic base body 10.

The soft magnetic metal particles contained in the magnetic base body 10 contain Fe at a content percentage of 95 wt % or more so that the magnetic base body 10 has high magnetic saturation characteristics. The content percentage of Fe in the soft magnetic metal particles contained in the magnetic base body 10 is measured by cutting the magnetic base body 10 along the coil axis Ax to expose a section of the magnetic base body 10 and performing energy dispersive X-ray spectroscopy (EDS) analysis on this section. The content percentage of Fe can be measured by scanning electron microscopy (SEM) equipped with an energy dispersive X-ray spectroscopy (EDS) detector. The EDS analysis by SEM equipped with the EDS detector is called SEM-EDS analysis. The content percentage of Fe is measured, for example, using a scanning electron microscope SU7000 from Hitachi High-Tech Corporation and an energy dispersive X-ray spectroscopy detector Octane Elite from Ametek, Inc. at an acceleration voltage of 5 kV. The content percentages of elements other than Fe contained in the first soft magnetic metal particle 30a are also measured by SEM-EDS analysis, as is the content percentage of Fe.

The surface of each of the soft magnetic metal particles contained in the magnetic base body 10 is covered by an insulating film. Thus, the soft magnetic metal particles contained in the magnetic base body 10 are electrically insulated from each other. For example, the surface of the first soft magnetic metal particle 30a is covered by the first insulating film 40a, and the surface of the second soft magnetic metal particle 30b is covered by the second insulating film 40b. The first insulating film 40a should preferably cover the entire surface of the first soft magnetic metal particle 30a, and the second insulating film 40b should preferably cover the entire surface of the second soft magnetic metal particle 30b. In the magnetic base body 10, each soft magnetic metal particle is bonded to adjacent soft magnetic metal particles via insulating films provided on their respective surfaces. In other words, the insulating films provided on the surfaces of adjacent soft magnetic metal particles are bonded to each other, and this bonding of the insulating films forms bonding of the soft magnetic metal particles covered by the insulating films. For example, the first soft magnetic metal particle 30a is bonded to the second soft magnetic metal particle 30b adjacent to the first soft magnetic metal particle 30a via the first insulating film 40a provided on the surface of the first soft magnetic metal particle 30a and the second insulating film 40b provided on the surface of the second soft magnetic metal particle 30b. Since the surfaces of the soft magnetic metal particles are covered by the insulating films, the magnetic base body 10 has a volume resistivity of 10⁵Ω·cm or higher.

The soft magnetic metal particles contained in the magnetic base body 10 are produced, for example, by heating a raw powder made of soft magnetic material. As described later, the magnetic base body 10 can be made by mixing soft magnetic metal powder of the soft magnetic material with resin to produce a mixed resin composition, and then heating this mixed resin composition. The heat treatment in the manufacturing process of the magnetic base body 10 causes the elements contained in the raw powder to diffuse to the surface of the raw powder and oxidize at the surface of the raw powder, and as a result, insulating films that contain oxides of the elements contained in the raw powder are formed on the surfaces of the soft magnetic metal particles.

The raw powder for the soft magnetic metal particles contained in the base body 10 is mainly composed of Fe. The raw powder for the soft magnetic metal particles contained in the magnetic base body 10 can contain additive elements in addition to Fe. For example, the raw powder for the soft magnetic metal particles contained in the magnetic base body 10 can contain silicon (Si) and aluminum (Al) as additives, in addition to Fe. The raw powder may further contain magnesium (Mg). The raw powder for the soft magnetic metal particles may contain both Al and Mg. The raw powder for the soft magnetic metal particles may further contain chromium (Cr). The raw powder for the soft magnetic metal particles may contain a trace amount of at least one element selected from the group consisting of titanium (Ti), zinc (Zn), and manganese (Mn).

Since Al is significantly more apt to oxidation than Fe, Al is oxidized prior to Fe when the raw powder is heat-treated in an atmosphere containing oxygen. Thus, the presence of Al in addition to Fe in the raw powder inhibits the oxidation of Fe. Further, when the raw powder contains Al, an oxide film containing an oxide of Al (Al₂O₃) is easily formed to cover the surface of the raw powder, even if the amount of oxygen around the raw powder is small.

As with Al, Mg is also significantly more apt to oxidation than Fe, and therefore, Mg is oxidized prior to Fe when the raw powder is heat-treated in an atmosphere containing oxygen. Thus, the presence of Al and Mg in addition to Fe in the raw powder inhibits the oxidation of Fe. Further, when the raw powder contains Al and Mg, an oxide film containing an oxide of Al and an oxide of Mg (MgO) is easily formed to cover the surface of the raw powder, even if the amount of oxygen around the raw powder is small.

When the raw powder contains Si, the hardness of the raw powder can be increased. The use of raw powder with increased hardness facilitates the production of a compact that is uniform overall by compression molding.

When the raw powder contains Cr, the oxidation of Fe is likely to produce chromite, which is insulating, rather than magnetite, which is conductive. Therefore, the presence of Cr in the raw powder improves the insulating property of the magnetic base body 10.

When the raw powder is heated, Si, Al, Mg, and Cr are thermally diffused to the surface of the raw powder and oxidized by oxygen in the atmosphere, but some of each element remains in the soft magnetic metal particles.

The insulating films provided on the surfaces of the soft magnetic metal particles contained in the magnetic base body 10 contain oxides of the elements contained in the raw powder. The “insulating films provided on the surfaces of the soft magnetic metal particles contained in the magnetic base body 10” include the first insulating film 40a provided on the surface of the first soft magnetic metal particle 30a and the second insulating film 40b provided on the surface of the second soft magnetic metal particle 30b. For convenience of description, the insulating films provided on the surfaces of the soft magnetic metal particles contained in the magnetic base body 10 may be referred to simply as the “insulating films.” Since Al and Si are more apt to oxidation than Fe, when the raw powder contains Al and Si in addition to Fe, the insulating films contain an oxide of Al and an oxide of Si. When the raw powder contains Mg, the insulating films contain an oxide of Mg. The insulating films may contain a trace amount of an oxide of at least one element selected from the group consisting of titanium (Ti), zinc (Zn), and manganese (Mn).

In one embodiment, the thickness of the insulating film is equal to the distance between the soft magnetic metal particles adjacent to each other. The thickness of the insulating films provided on the surfaces of the soft magnetic metal particles may be an average of distances between adjacent ones of a plurality of soft magnetic metal particles included in an observation field corresponding to a middle region of a section of the magnetic base body 10 observed with a predetermined magnification (e.g., 10000-fold magnification). The thickness of the insulating film is, for example, 5 to 20 nm. The thickness of the insulating film need not be uniform along the circumferential direction of the soft magnetic metal particle. In other words, the insulating film may have different thicknesses at different locations in the circumferential direction of the soft magnetic metal particle. If the insulating film has different thicknesses in accordance with the location in the circumferential direction of the soft magnetic metal particle, the average of the different thicknesses can be taken as the thickness of the insulating film. The thickness of the thinnest portion of the insulating film may be smaller than 5 nm. The thickness of the thickest portion of the insulating film may be larger than 20 nm. If the insulating film has different thicknesses in accordance with the location in the circumferential direction of the soft magnetic metal particle, its largest thickness is smaller than ten times its smallest thickness.

The magnetic base body 10 is filled with soft magnetic metal particles at a filling factor of 85% or higher. The filling factor of the soft magnetic metal particles in the magnetic base body 10 is determined as follows. The magnetic base body 10 is cut along the thickness direction (T-axis direction) to expose a section, and the section is scanned by a scanning electron microscope (SEM) to take an SEM image at, e.g., a 10000 to 50000-fold magnification. In this SEM image, the proportion of the area occupied by the soft magnetic metal particles in the entire area of the observed field is taken as the filling factor of the soft magnetic metal particles in the magnetic base body 10. The area occupied by the soft magnetic metal particles in the observed field of the SEM image may be obtained by excluding the areas of gaps and insulating films in the observed field from the entire area of the observed field of the SEM image.

In one aspect, the KAM value of the soft magnetic metal particles contained in the magnetic base body 10 is equal to or less than 0.6. The KAM value of the soft magnetic metal particles contained in the magnetic base body 10 may be equal to or less than 0.5. The KAM value of the soft magnetic metal particles contained in the magnetic base body 10 is equal to or greater than 0.3. The KAM value of the soft magnetic metal particles contained in the magnetic base body 10 can be calculated as follows. The magnetic base body 10 is cut along its thickness direction (T-axis direction) to expose a section, and a region around the middle of the section is polished. In the polished section of the magnetic base body, an EBSD measurement is performed by a scanning electron microscope (SEM) equipped with an electron backscatter diffraction (EBSD) detector at an acceleration voltage of 15 kV, a magnification of 10000, and a step size of 0.05 μm to obtain an IQ map showing the distribution of image quality (IQ value) in the observed field. The regions where the IQ value is equal to or higher than a predetermined threshold value are identified as the regions where soft magnetic metal particles are present. This threshold value can be set to a value from 15% to 30%. For thus identified regions where the soft magnetic metal particles are present, the average value of kernel average misorientation (KAM value) is obtained from the EBSD pattern. The average KAM value calculated in this way for the regions in the observed field where the soft magnetic metal particles are present can be taken as the KAM value of the soft magnetic metal particles in the magnetic base body 10. The above measurement may be performed using a scanning electron microscope SU7000 from Hitachi High-Tech Corporation and an EBSD detector EBSD Velocity from Ametek, Inc.

With reference to FIG. 4, a further description is given of the insulating films covering the surfaces of the soft magnetic metal particles. As shown in FIG. 4, the first insulating film 40a includes a first oxide region 41a and a second oxide region 42a. The first oxide region 41a covers a first surface region 31a constituting a part of the surface of the first soft magnetic metal particle 30a and contains an oxide of Al (Al₂O₃) or an oxide of Mg (MgO) as a main component. The second oxide region 42a covers a second surface region 32a constituting a part of the surface of the first soft magnetic metal particle 30a and contains an oxide of Si (SiO₂) as a main component.

The first oxide region 41a contains alumina (Al₂O₃) as the main component. In the case where the EDS analysis shows that the amount of Al element (atomic percentage (at %) of Al element) is the largest among those of the elements other than oxygen contained in the first oxide region 41a, it can be determined that the first oxide region 41a contains alumina as the main component. Since the first oxide region 41a is mainly composed of alumina, which is insulating, the first oxide region 41a has a high insulating quality. In the case where the first oxide region 41a may contain an oxide of aluminum other than alumina (e.g., aluminum oxide (II)), the Raman spectroscopic analysis may be performed to determine that the oxide contained as the main component in the first oxide region 41a is alumina (aluminum oxide (III)) rather than aluminum oxide (II).

The second oxide region 42a contains silica (SiO₂) as the main component. In the case where the EDS analysis shows that the amount of Si element (atomic percentage (at %) of Si element) is the largest among those of the elements other than oxygen contained in the second oxide region 42a, it can be determined that the second oxide region 42a contains silica as the main component. Since the second oxide region 42a is mainly composed of silica, which is insulating, the second oxide region 42a has a high insulating quality. In the case where the second oxide region 42a may contain an oxide of silicon other than silica (e.g., silicon monoxide), the Raman spectroscopic analysis may be performed to determine that the oxide contained as the main component in the second oxide region 42a is silica (silicon dioxide) rather than silicon monoxide.

The insulating film may contain nitrides of the elements contained in the raw powder in addition to oxides of the elements. The percentage of oxides in the insulating film (on a mass basis) is greater than the percentage of nitrides in the insulating film. The nitrides contained in the insulating film may include aluminum nitride and silicon nitride. The presence of the nitrides of the elements contained in the raw powder in the insulating film inhibits excessive oxidation of the elements contained in the raw powder. In general, oxides have higher hardness than nitrides, so the presence of a larger amount of oxides than nitrides in the insulating film can increase the mechanical strength of the magnetic base body 10.

The surface of the first soft magnetic metal particle 30a is partitioned into the first surface region 31a and the second surface region 32a. Since the first surface region 31a of the surface of the first soft magnetic metal particle 30a is covered by the first oxide region 41a, and the second surface region 32a is covered by the second oxide region 42a, the entire surface of the first soft magnetic metal particle 30a is covered by the first and second oxide regions 41a and 42a each having a high insulating quality.

The first oxide region 41a may cover at least a part of the outer surface of the second oxide region 42a, in addition to the first surface region 31a of the first soft magnetic metal particle 30a. The first oxide region 41a covering the outer surface of the second oxide region 42a can cover any portion of the second oxide region 42a having a defect, thereby preventing dielectric breakdown from occurring from the defect in the second oxide region 42a. In the aspect shown in FIG. 4, the entire outer surface of the second oxide region 42a is covered by the first oxide region 41a. The first oxide region 41a covering the entire outer surface of the second oxide region 42a further inhibits dielectric breakdown.

It is also possible that the first oxide region 41a covers only a part of the outer surface of the second oxide region 42a. In this case, the amount of the first oxide region 41a on the surface of the first soft magnetic metal particle 30a can be reduced. Therefore, the first oxide region 41a covering only a part of the outer surface of the second oxide region 42a can improve the filling factor of the soft magnetic metal particles in the magnetic base body 10, compared to the aspect in which the first oxide region 41a covers the entire outer surface of the second oxide region 42a.

In the embodiment shown in FIG. 4, the first insulating film 40a includes a plurality of second oxide regions 42a that are spaced apart from each other. In this way, the second oxide regions 42a containing an oxide of Si as the main component is not formed in a layer covering the entire surface of the first soft magnetic metal particle 30a, but is formed discretely on the surface of the first soft magnetic metal particle 30a. When the raw powder contains 4 wt % or less Si, the plurality of second oxide regions 42a can be formed discretely on the surface of the first soft magnetic metal particle 30a. The content percentage of Si in the raw powder may be 1 to 4 wt %. The content percentage of Al may be 1 wt % or less such that the insulating film has a small thickness. When the raw powder contains Mg or when the raw powder is a mixture of Fe—Si—Al alloy and Mg powder, the content percentage of Mg can be 1 wt % or less in total with Al.

A second insulating film 40b is provided on the surface of the second soft magnetic metal particle 30b, which is positioned adjacent to the first soft magnetic metal particle 30a. The second insulating film 40b includes a first oxide region 41b and a second oxide region 42b. The first oxide region 41b covers a first surface region 31b constituting a part of the surface of the second soft magnetic metal particle 30b and contains an oxide of Al as a main component. The second oxide region 42b covers a second surface region 32b constituting a part of the surface of the second soft magnetic metal particle 30b and contains an oxide of Si as a main component. The first oxide region 41b contains an oxide of Al as a main component, as does the first oxide region 41a. The above description related to the first oxide region 41a applies to the first oxide region 41b. The second oxide region 42b contains an oxide of Si as a main component, as does the second oxide region 42a.

In the magnetic base body 10, the soft magnetic metal particles are covered by the insulating films containing oxides of Al and Si, and thus the insulating quality of the magnetic base body 10 can be increased. In order to achieve a high insulating quality with an insulating film composed of a single kind of oxide, the entire surfaces of the soft magnetic metal particles must be covered by a layer of this oxide. In the magnetic base body 10, even if there are regions on the surfaces of the soft magnetic metal particles that are not coated with an oxide of Si, those regions can be coated with an oxide of Al. Specifically, in the magnetic base body 10, the second oxide region 42a is formed only on a part of the first soft magnetic metal particle 30a (i.e., only on the second surface region 32a), while the first oxide region 41a, which is mainly composed of an oxide of Al, covers the other region of the surface of the first soft magnetic metal particle 30a (i.e., the first surface region 31a). Therefore, the decrease in insulating quality due to exposure of a part of the surface of the first soft magnetic metal particle 30a can be inhibited. The soft magnetic metal particles other than the first soft magnetic metal particle 30a contained in the magnetic base body 10 are also covered by the insulating film containing the oxides of two different elements (i.e., Al and Si), and thus the magnetic base body 10 can have a high insulating quality.

A description will now be given of the difference between the insulating film provided on the surfaces of the soft magnetic metal particles contained in the magnetic base body 10 of the present application (e.g., the first insulating film 40a) and the insulating film provided on the surfaces of the conventional soft magnetic metal particles. Conventionally, in the case where the insulating film covering the surfaces of soft magnetic metal particles contains oxides of two or more elements, the insulating film has a layered structure in which the oxide of each element is formed in a layer and these oxide layers are stacked. In other words, the insulating film of the conventional magnetic base body includes a first oxide layer mainly composed of the oxide of a first element and a second oxide layer mainly composed of the oxide of a second element. The first oxide layer covers the entire outer surface of the soft magnetic metal particle, and the second oxide layer covers the entire outer surface of the first oxide layer. One example of the conventional magnetic base body in which the insulating film has a layered structure is disclosed in Japanese Patent Application Publication No. 2021-158261.

In contrast, in the magnetic base body 10 of the present application, the first surface region 31a of the surface of the first soft magnetic metal particle 30a is covered by the first oxide region 41a, and the second surface region 32a of the first soft magnetic metal particle 30a is covered by the second oxide region 42a. Therefore, in the magnetic base body 10 to which the present invention is applied, the proportion of the insulating film in the magnetic base body 10 can be reduced compared to the conventional magnetic base bodies that have an insulating film constituted by two or more oxide layers stacked together. As a result, the filling factor of the soft magnetic metal particles in the magnetic base body 10 can be increased to 85% or higher, and thus the magnetic characteristics can be improved compared to conventional magnetic base bodies having an insulating film constituted by two or more oxide layers stacked together.

As mentioned above, the oxide of Al in the insulating films covering the surfaces of the soft magnetic metal particles contained in the magnetic base body 10 may be formed from Al in the raw powder for the soft magnetic metal particles, but in another embodiment, it is possible that the oxide of Al is not formed from the raw powder for the soft magnetic metal particles. For example, the raw powder for the soft magnetic metal particles and alumina particles may be mixed together in a friction mixer such that the alumina particles are fixed to the surfaces of the soft magnetic metal particles. This allows an oxide of Al that is not formed from the Al element contained in the raw powder to adhere to the surfaces of the soft magnetic metal particles. The first oxide regions 41a and 41b may be formed from the alumina powder adhered to the soft magnetic metal particles. In the case where the oxide of Al in the insulating film covering the surfaces of the soft magnetic metal particles is not formed from an element contained in the raw powder, it is possible that the raw powder does not contain Al. Likewise, it is possible that the oxide of Mg in the insulating films covering the surfaces of the soft magnetic metal particles contained in the magnetic base body 10 is not formed from the raw powder for the soft magnetic metal particles. For example, the raw powder for the soft magnetic metal particles and the raw powder for metal powder of Mg may be mixed together in a friction mixer such that the magnesium powder is fixed to the surfaces of the soft magnetic metal particles. This allows an oxide of Mg that is not formed from the Mg element contained in the raw powder to adhere to the surfaces of the soft magnetic metal particles. This raw powder of magnesium can be either metal powder or oxide powder.

As mentioned above, the oxide of Si in the insulating films covering the surfaces of the soft magnetic metal particles contained in the magnetic base body 10 may be formed from Si in the raw powder for the soft magnetic metal particles, but in another embodiment, it is possible that the oxide of Si is not formed from the raw powder for the soft magnetic metal particles. For example, an oxide of Si (silica) can be formed on the surface of the raw powder (soft magnetic metal particles) by impregnating the raw powder with a mixed solution of TEOS (tetraethoxysilane), ethanol, and ammonia water, stirring this mixed solution, and then drying it. The oxide of Si thus formed may be amorphous. This allows the oxide of Si that is not formed from the Si element contained in the raw powder to adhere to the surfaces of the soft magnetic metal particles. The second oxide regions 42a and 42b may be made of silica formed on the surfaces of the soft magnetic metal particles. In the case where the oxide of Si in the insulating film covering the surfaces of the soft magnetic metal particles is not formed from an element contained in the raw powder, it is possible that the raw powder does not contain Si.

In the case where the oxide of Al and the oxide of Si in the insulating film covering the surfaces of the soft magnetic metal particles are not formed from Al or Si contained in the raw powder, it is possible to reduce the content percentages of Al and Si in the raw powder. In the case where the oxide of Al in the insulating film is not formed from Al contained in the raw powder, it is possible that the content percentage of Al in the raw powder is 0.1 to 0.8 wt %. In the case where the oxide of Si in the insulating film is not formed from Si contained in the raw powder, it is possible that the content percentage of Si in the raw powder is 0.7 to 2.5 wt %. By reducing the content percentages of Al and Si in the raw powder, the content percentage of Fe in the raw powder can be increased, and consequently the content percentage of Fe in the soft magnetic metal particles can also be increased.

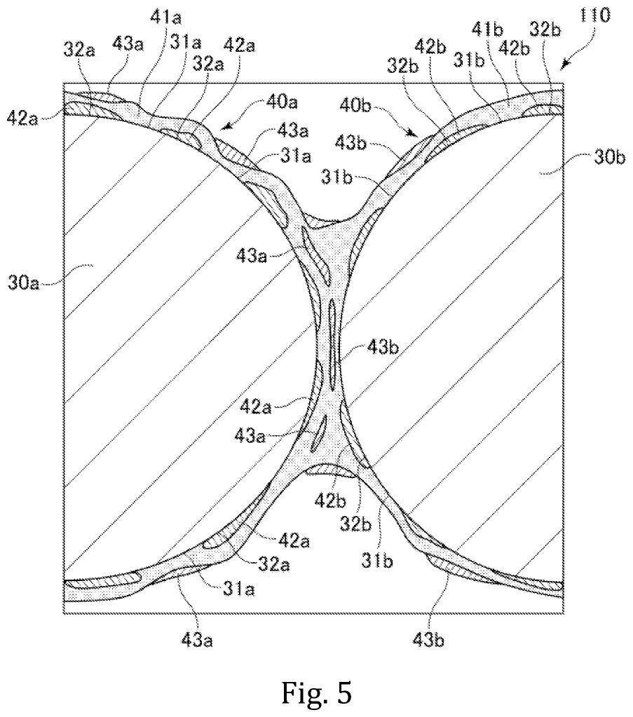

The following describes another embodiment of a base body to which the present invention is applied, with reference to FIG. 5. FIG. 5 is an enlarged sectional view schematically showing, on an enlarged scale, a part of a section of the magnetic base body 110 according to another embodiment. The magnetic base body 110 shown in FIG. 5 differs from the magnetic base body 10 in that the insulating films include a third oxide region that is mainly composed of an oxide of Cr. As shown in FIG. 5, in the magnetic base body 110, the first insulating film 40a covering the first soft magnetic metal particle 30a has a third oxide region 43a in addition to the first oxide region 41a and the second oxide region 42a, and the second insulating film 40b covering the second soft magnetic metal particle 30b has a third oxide region 43b in addition to the first oxide region 41b and the second oxide region 42b. The first insulating film 40a may include a plurality of third oxide regions 43a that are spaced apart from each other. The second insulating film 40b may include a plurality of third oxide regions 43b that are spaced apart from each other.

The third oxide region 43a is spaced apart from the surface of the first soft magnetic metal particle 30a. In other words, at least one of the first oxide region 41a or the second oxide region 42a is interposed between the third oxide region 43a and the surface of the first soft magnetic metal particle 30a. In the embodiment shown, the third oxide region 43a is also spaced apart from the second oxide region 42a. In other words, the first oxide region 41a is interposed between the third oxide region 43a and the second oxide region 42a. It is also possible that the third oxide region 43a is in contact with the second oxide region 42a.

The third oxide region 43a is located on the outer side of the first oxide region 41a in the radial direction of the first soft magnetic metal particle 30a. In one embodiment, at least one of a plurality of third oxide regions 43a may be provided at a position corresponding to the first surface region 31a in the circumferential direction around the first soft magnetic metal particle 30a. In other words, at least one of the plurality of third oxide regions 43a may be provided on the radially outer side of the first surface region 31a. The region corresponding to the first surface region 31a in the circumferential direction of the first soft magnetic particle 30a contains the first oxide region 41a and does not contain the second oxide region 42a. On the other hand, the region corresponding to the second surface region 32a in the circumferential direction of the first soft magnetic particle 30a contains the second oxide region 42a and the first oxide region 41a provided on the radially outer side thereof. Therefore, the first oxide region 41a is concave inwardly at a position corresponding to the first surface region 31a in the circumferential direction of the first soft magnetic metal particle 30a. In one embodiment, the third oxide region 43a is located in a cavity of the first oxide region 41a at a position corresponding to the first surface region 31a in the circumferential direction of the first soft magnetic metal particle 30a. Since the third oxide region 43a is provided in the cavity of the first oxide region 41a, the thickness of the first insulating film 40a can be uniform in the circumferential direction. In the case where a portion of the first insulating film 40a is thinner than other portions, dielectric breakdown may occur from the thinner portion. The uniform thickness of the first insulating film 40a in the circumferential direction prevents dielectric breakdown from occurring from a thin portion of the first insulating film 40a.

As with the third oxide region 43a, the third oxide region 43b is spaced apart from the surface of the second soft magnetic metal particle 30b. The third oxide region 43b may also be spaced apart from the second oxide region 42b. It is also possible that the third oxide region 43b is in contact with the second oxide region 42b. Further, the third oxide region 43b may be located in a cavity of the first oxide region 41b at a position corresponding to the first surface region 31b in the circumferential direction of the second soft magnetic metal particle 30b.

The third oxide regions 43a and 43b contain an oxide of Cr as a main component. The third oxide regions 43a and 43b contain chromite (FeCr₂O₄) as a main component. When an oxide including Fe is formed in the insulating films covering the Fe-based soft magnetic metal particles, the oxide of Fe may be present as hematite (Fe₂O₃) or magnetite (Fe₃O₄). The mixed presence of hematite, which is non-magnetic, and magnetite, which is ferromagnetic, between soft magnetic metal particles facilitates local magnetic saturation in the region where magnetite is present. With chromite, which is non-magnetic, as a main component of the third oxide region 43a containing Fe, the uniformity of magnetic flux between the soft magnetic metal particles can be improved, and as a result, the occurrence of local magnetic saturation between the soft magnetic metal particles can be inhibited. This improves the magnetic saturation characteristics of the magnetic base body 110 compared to magnetic base bodies containing more magnetite.

The third oxide regions 43a and 43b included in the insulating films may contain chromite (FeCr₂O₄), hematite (Fe₂O₃), and magnetite (Fe₃O₄). In one embodiment, in each of the third oxide regions 43a and 43b, the content percentage of chromite in the total of the aforementioned oxides (the total of chromite, hematite, and magnetite) may be 50% or more. With the content percentage of chromite, which is non-magnetic, being 50% or more, it is possible to reduce the specific permeability of the insulating films and improve the magnetic saturation characteristics of the magnetic base body 110, compared to the case with a high content percentage of ferromagnetic oxides (e.g., magnetite). In another embodiment, the sum of the content percentage of chromite and the content percentage of hematite in the total of the aforementioned oxides may be 80% or more. With the sum of the content percentages of chromite and hematite, which are non-magnetic, being 80% or more, it is possible to reduce the specific permeability of the insulating films and improve the magnetic saturation characteristics of the magnetic base body 110, compared to the case with a high content percentage of ferromagnetic oxides (e.g., magnetite).

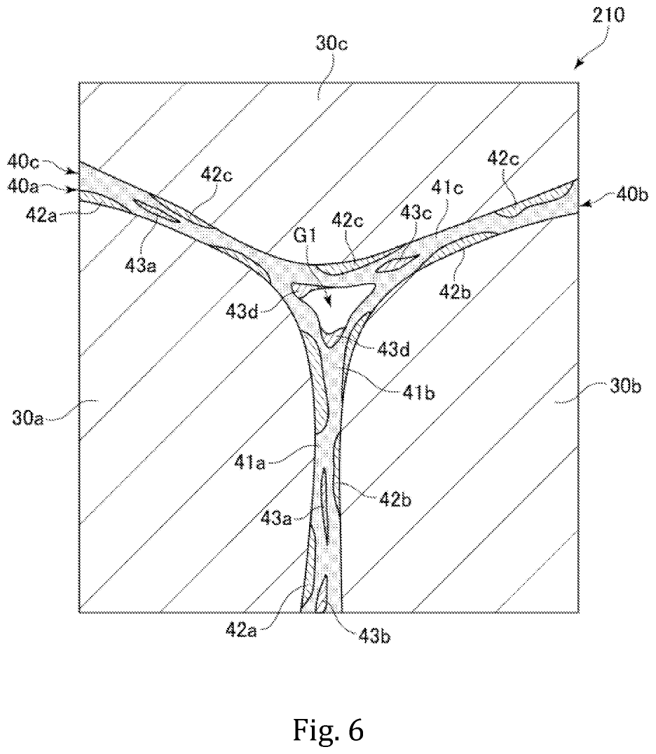

The following describes a magnetic base body 210 to which the present invention is applied, with reference to FIG. 6. FIG. 6 is an enlarged sectional view schematically showing a part of a cross section of the magnetic base body 210. The cross section of the magnetic base body 210 shown in FIG. 6 in an enlarged scale is positioned around the boundary of three soft magnetic metal particles. As shown, the magnetic base body 210 contains a first soft magnetic metal particle 30a, a second soft magnetic metal particle 30b, and a third soft magnetic metal particle 30c. The first soft magnetic metal particle 30a, the second soft magnetic metal particle 30b, and the third soft magnetic metal particle 30c are positioned adjacent to each other. As mentioned above, the first soft magnetic metal particle 30a is covered by the first insulating film 40a, and the second soft magnetic metal particle 30b is covered by the second insulating film 40b. Likewise, the third soft magnetic metal particle 30c is covered by the third insulating film 40c. The third insulating film 40c is configured in the same manner as the first insulating film 40a and the second insulating film 40b. Specifically, the third insulating film 40c includes a first oxide region 41c, a second oxide region 42c, and a third oxide region 43c. The first oxide region 41c covers a first surface region 31c constituting a part of the surface of the third soft magnetic metal particle 30c and contains an oxide of Al as a main component. The second oxide region 42c covers a second surface region 32c constituting a part of the surface of the second soft magnetic metal particle 30c and contains an oxide of Si as a main component. The third oxide region 43c is spaced apart from the surface of the third soft magnetic metal particle 30c and contains an oxide of Cr as a main component. As with the third oxide regions 43a and 43b, the third oxide region 43c may contain chromite as a main component.

In the magnetic base body 210, there is a gap among the soft magnetic metal particles that is not filled with the insulating films. For example, as shown in FIG. 6, a gap G1 is present among the first soft magnetic metal particle 30a, the second soft magnetic metal particle 30b, and the third soft magnetic metal particle 30c in the magnetic base body 210. At least a part of the gap G1 is defined by a third oxide region 43d, which contains an oxide of Cr as a main component. In other words, the third oxide region 43d is positioned to face the gap among the soft magnetic metal particles. As with the third oxide regions 43a to 43c, the third oxide region 43d may contain chromite as a main component. In the example shown, the gap G1 is defined by the third oxide region 43d and the first oxide regions 41a to 41c.

In the magnetic base body 210, a part of the gap among the soft magnetic metal particles is filled by the third oxide region 43d, and thus the mechanical strength of the magnetic base body 210 can be improved as compared to the case where the third oxide region 43d is not present. When the main component of the third oxide region 43d is chromite, a part of the gap is filled by the third oxide region 43d mainly composed of chromite having a high hardness, and thus the mechanical strength of the magnetic base body 210 can be further improved.

The first insulating film 40a may further contain a fourth oxide region, in addition to the first oxide region 41a, the second oxide region 42a, and the third oxide region 43a. The fourth oxide region may contain either oxides formed from elements contained in the raw powder for the soft magnetic metal particles or other oxides. The fourth oxide region may be insulating.

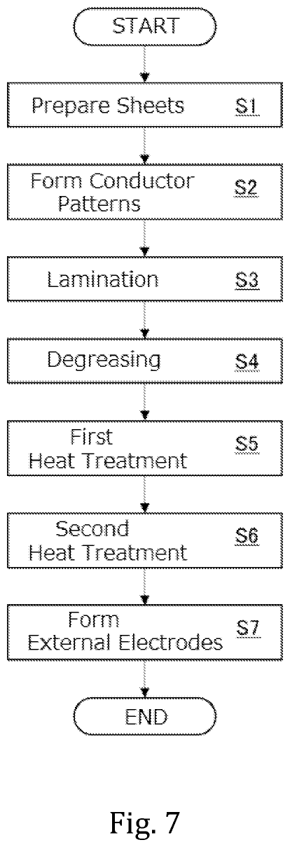

Next, one example of a manufacturing method of the coil component 1 will be described with reference to FIG. 7. Since the magnetic base body 10 is fabricated in the process of manufacturing the coil component 1, the manufacturing method of the magnetic base body 10 is also described with reference to FIG. 7. In the case where the raw powder contains Cr, the magnetic base body 110 or the magnetic base body 210 containing oxide of Cr is fabricated in place of the magnetic base body 10 in the process of FIG. 7. FIG. 7 is a flowchart showing a manufacturing method of the coil component 1 according to one embodiment of the present invention. In the following, it is assumed that the coil component 1 is manufactured by the sheet lamination method. The coil component 1 may also be manufactured by any known methods other than the sheet lamination method. For example, the coil component 1 may be manufactured by a lamination method such as a printing lamination method, a thin-film process method, or a slurry build method.

In the first step S1, magnetic sheets are fabricated. The magnetic sheets are produced from a magnetic material paste obtained by mixing and kneading soft magnetic metal powder (raw powder), which is the raw material of the soft magnetic metal particles, with a binder resin and a solvent. The raw powder is formed of a soft magnetic metal material. The raw powder contains Fe, Al, and Si. The raw powder may contain Cr. The raw powder contains 95 wt % or more Fe. The total of the content percentages of Al, Si, Cr and other additive elements is 5 wt % or less. The raw powder may contain 0.2 to 1 wt % Al. The raw powder may contain 1 to 4 wt % Si. The raw powder may contain 0.5 to 1 wt % Cr. The content percentage of Si in the raw powder may be higher than that of Al. The particle size of the raw powder is 10 μm or less. The particle size of the raw powder is 5 μm or less. With the particle size of the raw powder being 10 μm or less, or preferably 5 μm or less, the raw powder can be densely filled in the compact containing the raw powder, and the heat treatment can be performed stably.

The binder resin for the magnetic material paste is, for example, an acrylic resin. The binder resin for the magnetic material paste may be PVB resins, phenolic resins, other resins known as binder resins, or mixtures thereof. One example of the solvent is toluene. The magnetic material paste is applied to the surface of a plastic base film by the doctor blade method or other common methods. The magnetic material paste applied to the surface of the base film is dried to obtain sheet-shaped compacts. A molding pressure of approximately 10 MPa to 100 MPa is applied for molding to the sheet-shaped compacts in the mold, so that a plurality of magnetic sheets are obtained.

Next, in step S2, a conductive paste is applied to some of the plurality of magnetic sheets prepared in step S1. The conductive paste is produced by mixing and kneading conductive powder made of conductive materials having excellent conductivity, such as Ag, Pd, Cu, Al or alloys of these, with a binder resin and a solvent. The binder resin for the conductive paste may be the same as the binder resin for the magnetic material paste. Both the binder resins for the conductive paste and the magnetic material paste may be acrylic resins.

By applying the conductive paste to the magnetic sheets, unfired conductor patterns to be the conductor patterns C11 to C17 after firing are formed on the associated magnetic sheets. A through hole is formed in some of the magnetic sheets to penetrate the magnetic sheets in the stacking direction. When the conductive paste is applied to a magnetic sheet with a through hole, the conductive paste is also filled into the through hole. In this way, unfired via conductors are formed in the through holes of the magnetic sheets, and these unfired via conductors will be via conductors V1 to V6 after firing. The conductive paste is applied to the magnetic sheets by, for example, screen printing.

Next, in step S3, the magnetic sheets prepared in step S1 are stacked together to form a top laminate to be the top cover layer 18, an intermediate laminate to be the body layer 20, and a bottom laminate to be the bottom cover layer 19. The top laminate and the bottom laminate are each formed by stacking four magnetic sheets prepared in step S1 and having no unfired conductor pattern formed thereon. The four magnetic sheets of the top laminate will be the magnetic films 18a to 18d respectively in the finished coil component 1, and the four magnetic sheets of the bottom laminate will be the magnetic films 19a to 19d respectively in the finished coil component 1. The intermediate laminate is formed by stacking in a predetermined order seven magnetic sheets each having an unfired conductor pattern formed thereon. The seven magnetic sheets of the intermediate laminate will be the magnetic films 11 to 17 respectively in the finished coil component 1. The intermediate laminate formed in the above-described manner is sandwiched between the top laminate on the top side and the bottom laminate on the bottom side, and the top laminate and the bottom laminate are bonded to the intermediate laminate by thermal compression to obtain a body laminate. Next, the body laminate is diced to a desired size by using a cutter such as a dicing machine or a laser processing machine to obtain a chip laminate. The chip laminate is an example of a compact that includes an element body to be the magnetic base body 10 after the heat treatment and unfired conductor patterns to be the coil conductor 25 after the heat treatment. The compact that includes the element body to be the magnetic base body 10 after the heat treatment and the unfired conductor patterns to be the coil conductor 25 after the heat treatment may be fabricated by a method other than the sheet lamination method.

In the compact fabricated in step S3, the filling factor of the raw powder is 85% or higher. The filling factor of the raw powder in the compact is achieved by adjusting the molding pressure for molding the magnetic sheets in accordance with the type of binder resin, the particle size of the raw powder, and other parameters. In order to achieve a filling factor of 85% or more in the compact, the molding pressure for molding the magnetic sheets should desirably be about 10 to 100 MPa. The filling factor of the raw powder in the compact can be the proportion of the area occupied by the raw powder to the entire area of the observed field in a SEM image of a cross section of the compact, expressed in percentage.

Next, in step S4, the compact fabricated in step S3 is degreased. In the case where a thermally decomposable resin is used as the binder resin for the magnetic material paste and the conductive paste, the degreasing process for the compact may be performed in a non-oxygen atmosphere such as a nitrogen atmosphere. By performing the degreasing process in a non-oxygen atmosphere, the oxidation of Fe contained in the raw powder can be prevented during the degreasing process. The degreasing process is performed at a temperature higher than the thermal decomposition starting temperature of the binder resin for the magnetic material paste. In the case where an acrylic resin is used as the binder resin for the magnetic material paste, the degreasing process is performed at a temperature higher than the thermal decomposition starting temperature of the acrylic resin, e.g., 300° C. to 500° C. Since the degreasing process decomposes the thermally decomposable resin contained in the compact, no thermally decomposable resin remains in the compact after the degreasing process is completed. When the binder resin for the conductive paste is the same thermally decomposable resin as the binder resin for the magnetic material paste, the thermally decomposable resin contained in the unfired conductor patterns is also thermally decomposed during the degreasing process in step S4. Thus, in step S4, both the magnetic sheets and the unfired conductor patters constituting the compact are degreased.

Next, in step S5, the degreased compact is subjected to first heat treatment. The first heat treatment is performed in a low oxygen concentration atmosphere containing oxygen in a range of 5 to 1000 ppm at a first heating temperature of 590° C. to 900° C. The first heat treatment may be performed in a low oxygen concentration atmosphere of about 5 to 100 ppm. Since the raw powder is heated at 590° C. to 900° C., Al and Si in each raw powder diffuse to the vicinity of the surface by thermal diffusion and combine with oxygen in the atmosphere. In the case where the raw powder contains Cr, Cr also diffuses to the vicinity of the surface of the raw powder. In the first heat treatment, oxides of Al and Si, which are easily oxidized, are produced, among the additive elements transferred to the surface of the raw powder. As shown in FIGS. 4 to 6, the first heat treatment forms an oxide region composed mainly of the oxide of Al (e.g., the first oxide region 41a) and an oxide region composed mainly of the oxide of Si (e.g., the second oxide region 42a) on the surface of the heated raw powder. The first heating time during which the first heat treatment is performed can be between 1 and 6 hours. The first heating time may be, for example, one hour. In the first heat treatment, Fe, which is less apt to oxidation than Al and Si, may be slightly oxidized. Since the first heat treatment is performed in a low oxygen concentration atmosphere, oxidation of Fe produces more magnetite (Fe₃O₄) than hematite (Fe₂O₃) as oxides of Fe. In the first heat treatment, the oxides of Fe are produced on the radially outer side of the first oxide region 41a and the second oxide region 42a.

Since the first heat treatment is performed at a high temperature of 590° C. or higher, the first heat treatment can alleviate the distortion created in the compact during the pressure molding process for fabricating the magnetic sheets.

Next, in step S6, the compact having been heated in the first heat treatment is subjected to second heat treatment at a higher oxygen concentration than in the first heat treatment. The second heat treatment may be performed in a low oxygen atmosphere of higher than 1000 ppm and equal to or lower than 10000 ppm. Since the second heat treatment is performed at a higher oxygen concentration than the first heat treatment, the oxidation of Si and Al is further progressed. In the case where the raw powder contains Cr, magnetite produced in the first heat treatment combines with Cr to form chromite (FeCr₂O₄) during the second heat treatment. As mentioned above, the filling factor of the raw powder in the compact is as high as 85% or higher, and thus the excessive supply of oxygen to the surface of the raw powder can be inhibited. Therefore, in the second heat treatment, chromite (FeCr₂O₄) is more likely to be formed than hematite (Fe₂O₃) or chromium oxide (III) in the region where magnetite and Cr element are present near the surface of the raw powder.

Thus, in the case where the raw powder contains Cr, the second heat treatment produces an oxide region (e.g., the third oxide region 43a) containing chromite as a main component on the radially outer side of the first oxide region 41a or the second oxide region 42a. In the case where the raw powder does not contain Cr, chromite is not produced. Also, since the filling factor of the raw powder in the compact is high (e.g., 85% or higher), the amount of oxygen supplied to the surface of the raw powder can be restricted, and thus the range of oxygen concentration in the atmosphere in which the second heat treatment is performed can be expanded (i.e., the upper limit can be raised).

During the second heat treatment, in addition to oxidation of the raw powder, sintering of the conductive powder in the unsintered conductor patterns also occurs. The coil conductor 25 is obtained by sintering the conductive powder in the unsintered conductor patterns. When copper powder is used as the conductive powder, the copper crystals sinter densely to form the coil conductor 25.

The second heat treatment is performed at a second heating temperature and for a second heating time. The second heating temperature and the second heating time are determined such that insulating films with a sufficient thickness enough to ensure insulation are formed on the surface of the raw powder. The second heating temperature may be, for example, between 550° C. and 900° C. The higher the second heating temperature, the faster the oxidation progresses, so the second heating time depends on the second heating temperature. When the second heating temperature is 550° C., the second heating time may be from one to six hours. When the second heating temperature is 700° C., the second heating time may be from 30 minutes to one hour.

Thus, the raw powder contained in the compact is oxidized through the first heat treatment and the second heat treatment to produce, from the raw powder, soft magnetic metal particles with a surface covered by an insulating film. In the case where the raw powder does not contain Cr, as shown in FIG. 4 for example, produced are the first soft magnetic metal particle 30a covered by the first insulating film 40a and the second soft magnetic metal particle 30b covered by the second insulating film 40b. In the case where the raw powder contains Cr, as shown in FIG. 5 or 6, the first insulating film 40a is produced so as to include the third oxide region 43a containing chromite as a main component, and the second insulating film 40b is produced so as to include the third oxide region 43b containing chromite as a main component. The second heat treatment causes adjacent ones of the soft magnetic metal particles to bond with each other via insulating films formed on their surfaces. In this way, the magnetic base body 10, 110, or 210 containing soft magnetic metal particles bonded to each other is obtained.

Next, in step S7, the external electrode 21 and the external electrode 22 are formed on the surface of the magnetic base body 10 obtained in step S6. The external electrode 21 is connected to one end of the coil conductor 25, and the external electrode 22 is connected to the other end of the coil conductor 25. The compact having gone through the second heat treatment may be impregnated with a resin before the external electrodes 21 and 22 are formed. The compact is impregnated with, for example, a thermosetting resin such as an epoxy resin. This allows the resin to penetrate the gaps between the soft magnetic metal particles in the magnetic base body 10. The resin that has penetrated into the magnetic base body 10 may be set to increase the mechanical strength of the magnetic base body 10.

The coil component 1 is fabricated through the steps described above.

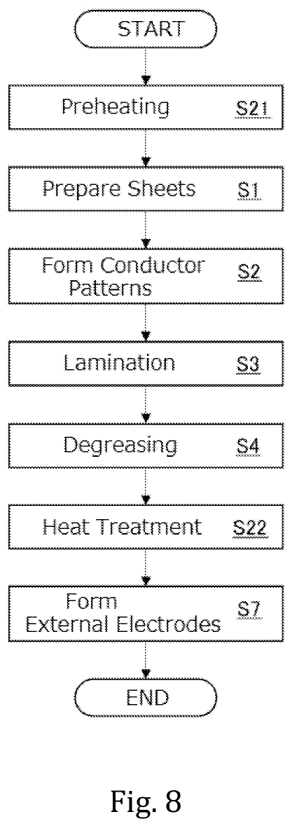

Next, another aspect of the manufacturing method of the coil component 1 will be described with reference to FIG. 8. The manufacturing method shown in FIG. 8 differs from that shown in FIG. 7 in that before the magnetic sheets are fabricated, the raw powder is preheated to produce oxides of Si on the surface of the raw powder.

As shown in FIG. 8, in the first step S21, the raw powder, which is the raw material for the soft magnetic metal particles, is prepared and then preheated. The preheating is performed at a temperature lower than 500° C. for one hour. The preheating discretely produces oxides of Si on the surface of the raw powder. Using this raw powder having the oxides of Si discretely formed on the surface thereof, steps S1 to S3 are performed as in FIG. 7 to produce a compact including the magnetic sheets stacked together. In step S4, the compact is degreased.

Next, in step S22, the degreased compact is subjected to heat treatment. The heat treatment in step S22 can be performed under the same conditions as the second heat treatment performed in step S6 of FIG. 7. Thus, Al in the raw powder contained in the compact is oxidized through the second heat treatment to produce oxides of Al, thereby producing, from the raw powder, soft magnetic metal particles with a surface covered by an insulating film. The heat treatment in step S22 causes adjacent ones of the soft magnetic metal particles to bond with each other via insulating films formed on their surfaces. In this way, the magnetic base body 10 containing soft magnetic metal particles bonded to each other is obtained.

Next, in step S7, the external electrode 21 and the external electrode 22 are formed on the surface of the magnetic base body 10 obtained in step S22. The coil component 1 is fabricated through the steps described above.

### EXAMPLES

According to steps S1 and S3 to S6 described above, samples of 16 types were prepared as follows by varying the composition of the raw powder, the first heating temperature, and the second heating temperature.

Samples 1 to 10 were prepared as follows. First, soft magnetic metal powder (raw powder) with an average particle diameter of 10 μm was prepared. The mass-based composition ratio of the soft magnetic metal powder was Fe: 95 wt %, Si: 4 wt %, and Al: 1%. The raw powder was mixed and kneaded with an acrylic resin and toluene (solvent) to obtain a magnetic material paste. The magnetic material paste was applied to the surface of a plastic base film, and the applied magnetic material paste was dried to obtain sheet-shaped compacts. Next, a molding pressure of approximately 50 MPa was applied for molding to the sheet-shaped compacts, so that magnetic sheets were obtained. Next, ten magnetic sheets were stacked together to prepare a sheet-shaped laminate. The sheet-shaped laminate was diced to produce chip-shaped elements each having a length of 1.6 mm, a width of 0.8 mm, and a height of 0.5 mm. Next, the chip-shaped elements were degreased. In the degreasing process, the chip-shaped elements were heated at 400° C. for 30 minutes in a nitrogen atmosphere. Next, the degreased compacts were subjected to heat treatment (first heat treatment) at first heating temperatures listed in Table 1 for three hours in a low oxygen atmosphere of 10 ppm. Next, the laminates having gone through the first heat treatment were subjected to heat treatment (second heat treatment) for one hour at second heating temperatures listed in Table 1 in a low oxygen atmosphere of 5000 ppm. Samples 1 to 10 were obtained in this manner.

Next, samples 11 to 13 were prepared as follows. First, soft magnetic metal powder (raw powder) with an average particle diameter of 10 μm was prepared. The mass-based composition ratio of the soft magnetic metal powder was Fe: 95 wt %, Si: 3.5 wt %, Al: 0.5 wt %, and Cr: 1 wt %. Using this raw powder, a laminate was prepared in the same manner as for samples 1 to 10, and the laminate was subjected to degreasing, first heat treatment, and second heat treatment in this order to obtain samples 11 to 13. The first heat treatment was performed at first heating temperatures listed in Table 1, and the second heat treatment was performed at second heating temperatures listed in Table 1.

Samples 14 to 16 were prepared as follows. First, soft magnetic metal powder having the same composition as the raw powder used for preparing samples 1 to 10 was mixed with magnesium oxide powder in a friction mixer, thereby adhering the magnesium oxide powder to the surface of the soft magnetic metal powder to obtain the raw powder. Using this raw powder (the raw powder in which the magnesium oxide powder is adhered to the surface of the soft magnetic metal powder), a laminate was prepared in the same manner as for samples 1 to 10, and the laminate was subjected to degreasing, first heat treatment, and second heat treatment in this order to obtain samples 14 to 16. The first heat treatment was performed at first heating temperatures listed in Table 1, and the second heat treatment was performed at second heating temperatures listed in Table 1.

The filling factors of samples 1 to 16 were then measured as follows. First, each sample was cut to expose a cross section, and the cross section was photographed by a scanning electron microscope (SEM) at a 10000-fold magnification to obtain an SEM image. In this SEM image, a region where soft magnetic metal particles were present was identified from the brightness difference, and the area of this region where soft magnetic metal particles were present was measured. The proportion of the area of the region where soft magnetic metal particles were present to the entire area of the observed field was calculated, and the calculated proportion expressed in a percentage was taken as the filling factor. The filling factors thus calculated were entered in the “Filling Factor” column of Table 1.

The KAM values of samples 1 to 16 were then measured as follows. First, each sample was cut to expose a cross section, and the cross section was polished. In the polished cross section of the magnetic base body, an EBSD measurement was performed by a SEM equipped with an EBSD detector at an acceleration voltage of 15 kV, a magnification of 10000, and a step size of 0.05 μm to obtain an IQ map showing the distribution of image quality (IQ value) in the observed field. In this IQ map, regions with an IQ value of 15% or greater were identified as regions where soft magnetic metal particles were present. For thus identified regions where the soft magnetic metal particles were present, the average KAM value was obtained from the EBSD pattern using data analysis software (OIM Analysis ver. 8.5). The average KAM values thus calculated were entered in the “KAM Value” column of Table 1.

Samples 1 to 16 were then set in 8600 SERIES VSM from Lake Shore, and the coercive forces of samples 1 to 16 were measured at a maximum magnetic field of 5 kOe. The coercive forces thus measured were entered in the “Coercive Force” column of Table 1.

TABLE 1

| | | 1st | 2nd | | | |
|---|---|---|---|---|---|---|
| | | Heating | Heating | | | Coercive |
| Sample | Magnetic | Temp. | Temp. | Filling | KAM | Force |
| No. | Material | [° C.] | [° C.] | Factor | Value | Hc[A/m] |
| 1* | FeSiAl | 90 | 90 | 85 | 0.78 | 1320 |
| 2* | FeSiAl | 400 | 400 | 85 | 0.77 | 1300 |
| 3* | FeSiAl | 500 | 500 | 85 | 0.75 | 1250 |
| 4* | FeSiAl | 550 | 550 | 85 | 0.74 | 940 |
| 5* | FeSiAl | 570 | 570 | 85 | 0.72 | 880 |
| 6 | FeSiAl | 590 | 550 | 85 | 0.6 | 730 |
| 7 | FeSiAl | 650 | 600 | 85 | 0.5 | 700 |
| 8 | FeSiAl | 650 | 800 | 85 | 0.39 | 670 |
| 9 | FeSiAl | 800 | 650 | 85 | 0.4 | 680 |
| 10 | FeSiAl | 880 | 650 | 85 | 0.38 | 660 |
| 11 | FeSiAlCr | 590 | 550 | 86 | 0.59 | 720 |
| 12 | FeSiAlCr | 650 | 600 | 86 | 0.48 | 680 |
| 13 | FeSiAlCr | 800 | 650 | 86 | 0.38 | 660 |
| 14 | FeSiAl + Mg | 590 | 550 | 85 | 0.58 | 710 |
| 15 | FeSiAl + Mg | 650 | 600 | 85 | 0.45 | 670 |
| 16 | FeSiAl + Mg | 800 | 650 | 85 | 0.35 | 650 |

In Table 1, samples not encompassed by the present invention (i.e., comparative examples) have an asterisk (*) added to the sample numbers. Specifically, samples 1 to 5 are comparative examples not encompassed by the present invention.

As shown in Table 1, the filling factor of each sample was equal to or greater than 85%. As shown in Table 1, the KAM values of samples 1 to 5 subjected to the first heat treatment at a first heating temperature of 570° C. or lower were 0.7 or higher, while the KAM values of samples 6 to 16 subjected to the first heat treatment at a first heating temperature of 590° C. or higher were 0.6 or lower. This confirmed that performing the first heat treatment at 590° C. or higher alleviates the distortion during compression molding and produces a KAM value of 0.6 or lower. Samples 6 to 16 with KAM values of 0.6 or less had coercive forces of 730 or less, which were smaller than those of samples 1 to 5. Therefore, the magnetic loss (hysteresis loss) can be small in samples 6 to 16.

The volume resistivities of samples 6 to 16 were measured in conformity to JIS-K6911. Specifically, with Au films formed on two opposite surfaces of each sample, a voltage was applied between the Au films as electrodes so that the electric field strength was 60 V/cm, and the resistance value was measured. The volume resistivity was calculated from the resistance value. Samples 6 to 16 all had a high volume resistivity of 10⁵Ω·cm or higher. Samples 6 to 7 and 9 to 16 were found to have a particularly high volume resistivity of 10⁷Ω·cm or higher. For comparison, the volume resistivity was measured of a magnetic base body made by the same method as sample 6 using raw powder not containing Al (Fe: 94 wt %, Si: 6 wt %). The measured volume resistivity was as low as about 10²Ω·cm. This result revealed that when the raw powder contains Al, which is easily oxidized, the surfaces of the soft magnetic metal particles can be covered by an oxide of Al, even with a small amount of oxygen supplied to the surface of the raw powder due to a high filling factor of the soft magnetic metal particles, thus making it possible to obtain a magnetic base body with a high insulating quality.

In the embodiments described herein, the soft magnetic metal particles in the magnetic base body 10 contain 95 wt % or more Fe, so the high concentration of Fe in the soft magnetic metal particles results in a magnetic base body 10 that exhibits high magnetic permeability and DC superposition characteristics. In addition, since the filling factor of the soft magnetic metal particles in the magnetic base body 10 is 85% or higher, the magnetic base body 10 has a high magnetic permeability. Thus, the magnetic base body 10 has excellent magnetic properties.

In the magnetic base body 10 according to the embodiments described herein, the filling factor of the soft magnetic metal particles is 85% or higher, and thus the amount of oxygen supplied to the surface of the raw powder during heating of the raw powder is restricted. Therefore, the oxidation of Fe contained in the raw powder is inhibited in the manufacturing process, so the soft magnetic metal particles contained in the magnetic base body 10 can contain 95 wt % or more Fe.

In addition, the raw powder for the soft magnetic metal particles contains Al, and therefore, even with a small amount of oxygen supplied to the surface of the raw powder, the surfaces of the soft magnetic metal particles can be covered by an insulating oxide film composed mainly of Al oxide, which provides the magnetic base body 10 with excellent insulating properties.

As described above, the embodiments described herein provide a magnetic base body 10 with excellent insulation and magnetic properties. The above description also applies to the magnetic base bodies 110 and 210.

The dimensions, materials, and arrangements of the constituent elements described for the above various embodiments are not limited to those explicitly described for the embodiments, and these constituent elements can be modified to have any dimensions, materials, and arrangements within the scope of the present invention.

Constituent elements not explicitly described herein can also be added to the above-described embodiments, and it is also possible to omit some of the constituent elements described for the embodiments.

The words “first,” “second,” “third” and so on used herein are added to distinguish constituent elements but do not necessarily limit the numbers, orders, or contents of the constituent elements. The numbers added to distinguish the constituent elements should be construed in each context. The same numbers do not necessarily denote the same constituent elements among the contexts. The use of numbers to identify constituent elements does not prevent the constituent elements from performing the functions of the constituent elements identified by other numbers.

This specification also discloses the following embodiments.

### ADDITIONAL EMBODIMENT 1

A magnetic base body, comprising:
a plurality of soft magnetic metal particles filled at a filling factor of 85% or higher, having a KAM value of 0.6 or less, and containing 95 wt % or more Fe, Si, and Al; and
a plurality of insulating films each covering a surface of corresponding one of the plurality of soft magnetic metal particles, the plurality of insulating films containing an oxide of Si and an oxide of Al.

### ADDITIONAL EMBODIMENT 2

The magnetic base body of Additional Embodiment 1, wherein the plurality of soft magnetic metal particles contain Mg.

### ADDITIONAL EMBODIMENT 3

The magnetic base body of Additional Embodiment 1 or 2,
wherein the plurality of soft magnetic metal particles contain Cr, and
wherein the plurality of insulating films contain chromite.

### ADDITIONAL EMBODIMENT 4

The magnetic base body of any one of Additional Embodiments 1 to 3,
wherein the filling factor of the plurality of soft magnetic metal particles is 86% or lower.

### ADDITIONAL EMBODIMENT 5

A coil component comprising:
the magnetic base body of any one of Additional Embodiments 1 to 4; and a coil conductor provided in the magnetic base body.

### ADDITIONAL EMBODIMENT 6

A circuit board comprising the coil component of Additional Embodiment 5.

### ADDITIONAL EMBODIMENT 7

An electronic device comprising the circuit board of Additional Embodiment 6.

### ADDITIONAL EMBODIMENT 8

A manufacturing method of a magnetic base body, comprising the steps of:
forming a compact containing a plurality of soft magnetic metal particles filled at a filling factor of 85% or higher, the plurality of soft magnetic metal particles containing 95 wt % or more Fe, Si, and Al;
performing a first heating process in which the compact is heated at 590 to 900° C. at a first oxygen concentration of 5 to 10 ppm; and
performing a second heating process in which the compact heated in the first heating process is heated at 550 to 900° C. at a first oxygen concentration of 5 to 10 ppm.

What is claimed is:

1. A magnetic base body, comprising:
a plurality of soft magnetic metal particles filled at a filling factor of 85% or higher, having a KAM value of 0.6 or less, and containing 95 wt % or more Fe, Si, and Al; and
a plurality of insulating films each covering a surface of corresponding one of the plurality of soft magnetic metal particles, the plurality of insulating films containing an oxide of Si and an oxide of Al.

2. The magnetic base body of claim 1, wherein the plurality of soft magnetic metal particles contain Mg.

3. The magnetic base body of claim 1,
wherein the plurality of soft magnetic metal particles contain Cr, and
wherein the plurality of insulating films contain chromite.

4. The magnetic base body of claim 1, wherein the filling factor of the plurality of soft magnetic metal particles is 87% or lower.

5. A coil component comprising:
the magnetic base body of claim 1; and
a coil conductor provided in the magnetic base body.
